(19) United States
(12) Patent Application Publication
(10) Pub. No.: US 2019/0169357 A1
(43) Pub. Date: Jun. 6, 2019

(54) LATENT CATALYST MIXTURE FOR EPOXY/ANHYDRIDE COMPOSITIONS

(71) Applicant: Dow Global Technologies LLC, Midland, MI (US)

(72) Inventors: Yanli Feng, Shanghai (CN); Minrong Zhu, Shanghai (CN); Shaoguang Feng, Shanghai (CN); Huan Chen, Beijing (CN); Jing Liu, Shanghai (CN)

(21) Appl. No.: 16/320,907

(22) PCT Filed: Jul. 27, 2016
(86) PCT No.: PCT/CN2016/091858

§ 371 Date: Jan. 25, 2019

(51) Int. Cl. C08G 59/42; C08G 59/68

(52) U.S. Cl. CPC C08G 59/42; C08G 59/686; C08G 59/685

(57) ABSTRACT

A composition comprising, consisting of, or consisting essentially of a) an epoxy resin; b) an anhydride hardener; and c) a latent catalyst which is a mixture of i) a Lewis acid catalyst; and ii) an imidazolium acetate catalyst, is disclosed.

### FIELD OF THE INVENTION

The present invention relates to epoxy compositions.

### INTRODUCTION

Latent, or delayed, catalysts have been widely used to lengthen the pot life of epoxy formulations. They provide good reactivity to meet the process requirements at or above the required temperature, and keep latency below the required temperature. Some applications which require latency include powder coatings, adhesives, and composites. Examples of latent catalysts that are widely used in the market include Ajicure PN-23 and MY-24. However, when using some latent catalysts, the reactivity of the epoxy formulation is often not fast enough to be used in particular applications, such as pultrusion processes. Therefore, a latent catalyst which can give an epoxy formulation adequate reactivity for these applications without sacrificing pot life length is desired.

### SUMMARY OF THE INVENTION

In one broad embodiment of the present invention, there is disclosed a composition comprising, consisting of, or consisting essentially of a) an epoxy resin; b) an anhydride hardener, and c) a latent catalyst which is a mixture of i) a Lewis acid catalyst; and ii) an imidazolium acetate catalyst.

In an alternative embodiment of the present invention, there is disclosed the composition described above wherein the epoxy resin is present in the composition in an amount in the range of from 30 to 95 phr and the anhydride hardener is present in the composition in an amount in the range of from 1 to 60 phr.

In an alternative embodiment of the present invention, there is disclosed the composition of either embodiment described above wherein the imidazolium acetate catalyst is selected from the group consisting of 1-ethyl, 2-methyl-imidazolium acetate, 1,3-di-tert-butyl-imidazolium acetate, 1,3-didamantyl-imidazolium acetate, 1,3-diisopropyl-imidazolium acetate, and 1-butyl-3-methylimidazolium acetate.

In an alternative embodiment of the present invention, there is disclosed the composition of any of the above embodiments, wherein the Lewis acid catalyst is chromium (III) carboxylate.

In an alternative embodiment of the present invention, there is disclosed the composition of any of the above embodiments wherein the latent catalyst is present in the composition in an amount in the range of from 0.1 to 15 phr.

In an alternative embodiment of the present invention, there is disclosed the composition of any of the above embodiments, wherein the ratio of Lewis acid catalyst to imidazolium acetate catalyst is in the range of from 1:10 to 10:1.

The present invention also discloses a process of making the composition of any one of the above embodiments, the process comprising a) admixing i) the epoxy resin; ii) the anhydride hardener, and iii) the latent catalyst; and b) activating the latent catalyst.

In an alternative embodiment of the present invention, there is disclosed the process above, wherein the latent catalyst is activated in step b) using heat.

The present invention also discloses a pultrusion process using the composition of any one of the above embodiments.

The present invention also discloses a composite prepared by the above-mentioned pultrusion process.

### DETAILED DESCRIPTION OF THE INVENTION

The composition of the present invention comprises an epoxy resin; b) an anhydride hardener; and c) a latent catalyst which is a mixture of i) a Lewis acid catalyst; and ii) an imidazolium acetate catalyst.

The epoxy resins used in embodiments disclosed herein can vary and include conventional and commercially available epoxy resins, which can be used alone or in combinations of two or more, including, for example, novolac resins and isocyanate modified epoxy resins, among others. In choosing epoxy resins for compositions disclosed herein, consideration should not only be given to properties of the final product, but also to viscosity and other properties that may influence the processing of the resin composition.

The epoxy resin component can be any type of epoxy resin useful in molding compositions, including any material containing one or more reactive oxirane groups, referred to herein as “epoxy groups” or “epoxy functionality.” Epoxy resins useful in embodiments disclosed herein can include mono-functional epoxy resins, multi- or poly-functional epoxy resins, and combinations thereof. Monomeric and polymeric epoxy resins can be aliphatic, cycloaliphatic, aromatic or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two, or more epoxy groups per molecule. In some embodiments, epoxy resins can also include reactive —OH groups, which can react at higher temperatures with anhydrides, organic acids, amino resins, phenolic resins, or with epoxy groups (when catalyzed) to result in additional crosslinking. In an embodiment, the epoxy resin is produced by contacting a glycidyl ether with a bisphenol compound, such as, for example, bisphenol A or tetrabromobisphenol A to form epoxy-terminated oligomers. In another embodiment, the epoxy resins can be advanced by reaction with isocyanates to form oxazolidinones. Suitable isocyanates include toluene diisocyanate and methylene diisocyanate (MDI or methylene bis(phenylene isocyanate)).

In general, the epoxy resins can be glycidated resins, cycloaliphatic resins, epoxidized oils, and so forth. The glycidated resins are frequently the reaction product of a glycidyl ether, such as epichlorohydrin, and a bisphenol compound such as bisphenol A; C₄ to C₂₈ alkyl glycidyl ethers; C₂ to C₂₈ alkyl- and alkenyl-glycidyl esters; C₁ to C₂₈ alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphynyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether, polyglycidyl ethers of polyphenols obtained by condensing phenols and long-chain halogen paraffins containing at least two halogen atoms. Other examples of epoxy resins useful in embodiments disclosed herein include bis-4,4′-(1-methylethylidene) phenol diglycidyl ether and (chloromethyl) oxirane bisphenol A diglycidyl ether.

In some embodiments, the epoxy resin can include glycidyl ether type; glycidyl-ester type; alicyclic type; heterocyclic type, and halogenated epoxy resins, etc. Non-limiting examples of suitable epoxy resins can include cresol novolac epoxy resins, phenolic novolac epoxy resins, biphenyl epoxy resins, hydroquinone epoxy resins, stilbene epoxy resins, and mixtures and combinations thereof.

Suitable polyepoxy compounds can include resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidyl ether of bromobisphenol A (2,2-bis(4-(2,3-epoxypropoxy)3-bromo-phenyl)propane), diglycidylether of bisphenol F (2,2-bis(p-(2,3-epoxypropoxy)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds.

Other suitable epoxy resins include polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether, and N,N,N′,N′-tetraglycidyl-1,3-propylene bis-4-aminobenzoate. Epoxy resins can also include glycidyl derivatives of one or more of: aromatic diamines, aromatic monoprimary amines, aminophenols, polyhydric phenols, polyhydric alcohols, polycarboxylic acids.

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-napthalene dicarboxylic acid, and dimerized linoleic acid; polyglycidyl ethers of polyphenols, such as, for example, bisphenol A, bisphenol F, 1,1-bis(4-hydroxyphenyl)ethane, 1,1-bis(4-hydroxyphenyl)isobutane, and 1,5-dihydroxy napthalene; modified epoxy resins with acrylate or urethane moieties; glycidlyamine epoxy resins; naphthalene epoxy resins and novolac resins.

The epoxy compounds can be cycloaliphatic or alicyclic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate; vinylcyclohexene diepoxide; limonene diepoxide; dicyclopentadiene diepoxide; and the like.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexylmethyl-3,4-epoxy-2-methylcyclohexane carboxylate; 3,4-epoxy-3-methylcyclohexyl-methyl-3,4-epoxy-3-methylcyclohexane carboxylate; 3,4-epoxy-5-methylcyclohexyl-methyl-3,4-epoxy-5-methylcyclohexane carboxylate and the like.

Further epoxy-containing materials which are useful include those based on glycidyl ether monomers. Examples are di- or polyglycidyl ethers of polyhydric phenols obtained by reacting a polyhydric phenol, such as a bisphenol compound with an excess of chlorohydrin such as epichlorohydrin. Such polyhydric phenols include resorcinol, bis(4-hydroxyphenyl)methane (known as bisphenol F), 2,2-bis(4-hydroxyphenyl)propane (known as bisphenol A), 2,2-bis(4′-hydroxy-3′,5′-dibromophenyl)propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Another class of epoxy compounds are polyglycidyl esters and poly(beta-methylglycidyl) esters of polyvalent carboxylic acids such as phthalic acid, terephthalic acid, tetrahydrophthalic acid or hexahydrophthalic acid. A further class of epoxy compounds are N-glycidyl derivatives of amines, amides and heterocyclic nitrogen bases such as N,N-diglycidyl aniline, N,N-diglycidyl toluidine, N,N,N′,N′-tetraglycidyl bis(4-aminophenyl)methane, triglycidyl isocyanurate, N,N′-diglycidyl ethyl urea, N,N′-diglycidyl-5,5-dimethylhydantoin, and N,N′-diglycidyl-5-isopropylhydantoin.

Still other epoxy-containing materials are copolymers of acrylic acid esters of glycidol such as glycidylacrylate and glycidylmethacrylate with one or more copolymerizable vinyl compounds. Examples of such copolymers are 1:1 styrene-glycidylmethacrylate, 1:1 methyl-methacrylateglycidylacrylate and a 62.5:24:13.5 methylmethacrylate-ethyl acrylate-glycidylmethacrylate.

Epoxy compounds that are readily available include octadecylene oxide; glycidylmethacrylate; diglycidyl ether of bisphenol A; D.E.R.™ 331 (bisphenol A liquid epoxy resin) and D.E.R.™ 332 (diglycidyl ether of bisphenol A) available from Olin; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl) adipate; bis(2,3-epoxycyclopentyl) ether; aliphatic epoxy modified with polypropylene glycol; dipentene dioxide; epoxidized polybutadiene; silicone resin containing epoxy functionality; flame retardant epoxy resins (such as a brominated bisphenol type epoxy resin available under the trade names D.E.R.™ 530, 538, 539, 560, 592, and 593, available from Olin); polyglycidyl ether of phenolformaldehyde novolac (such as those available under the tradenames D.E.N.™ 431 and D.E.N.™ 438 available from Olin); and resorcinol diglycidyl ether. Although not specifically mentioned, other epoxy resins under the tradename designations D.E.R.™ and D.E.N.™ available from Olin can also be used.

In an embodiment, the epoxy resin can be produced by contacting a glycidyl ether with a bisphenol compound and a polyisocyanate, such as toluene diisocyanate or ‘methylene diisocyanate’ (the diisocyanate of methylene dianiline), to form oxazolidinone moieties. These resins can be prepared using methods outlined in U.S. Pat. No. 5,112,932, which is incorporated herein by reference.

Other suitable epoxy resins include phenolic resins, benzoxazine resins, aryl cyanate resins, aryl triazine resins, and maleimide resins.

The epoxy resin is generally present in an amount in the range of from 30 to 95 parts per hundred (phr). Any and all amounts between 30 and 95 phr are included herein and disclosed herein, for example, the epoxy resin can be present in the composition in an amount in the range of from 30 to 95 phr, from 35 to 80 phr, or from 40 to 60 phr.

Examples of anhydride hardeners that can be used in the composition include, but are not limited to, phthalic acid anhydride and derivatives, nadic acid anhydride and derivatives, trimellitic acid anhydride and derivatives, pyromellitic acid anhydride and derivatives, benzophenonetetracarboxylic acid anhydride and derivatives, dodecenylsuccinic acid anhydride and derivatives, poly (ethyloctadecanedioic acid) anhydride and derivatives, styrene maleic anhydride and derivatives, and the like, and these can be used alone or in an admixture thereof. Hexahydrophthalic anhydride, methyl hexahydrophthalic anhydride, tetrahydrophthalic anhydride, methyl tetrahydrophthalic anhydride, nadic acid anhydride, methyl nadic acid anhydride, and styrene maleic anhydride are particularly suitable for this invention.

The anhydride hardener is generally present in the composition in an amount in the range of from 1 to 60 phr. Any and all amounts between 1 and 60 phr are included herein and disclosed herein, for example, the epoxy resin can be present in the composition in an amount in the range of from 1 to 60 phr, from 20 to 60 phr, or from 40 to 60 phr.

A latent catalyst mixture is used in the present invention. This mixture comprises a Lewis acid catalyst and an imidazolium acetate catalyst

Useful imidazolium acetate catalysts include, but are not limited to 1-ethyl, 2-methyl-imidazolium acetate, 1,3-di-tert-butyl-imidazolium acetate, 1,3-didamantyl-imidazolium acetate, 1,3-diisopropyl-imidazolium acetate, 1-butyl-3-methylimidazolium acetate, and others disclosed in US 2011/0201709 A1.

Any suitable Lewis acid catalyst can be used in the present invention. In various embodiments, chromium (III) catalysts, such as chromium (III) carboxylate catalysts are used.

The catalyst mixture is generally present in the composition in an amount in the range of from 0.1 to 15 phr. Any and all amounts between 0.1 and 15 phr are included herein and disclosed herein, for example, the latent catalyst mixture can be present in the composition in an amount in the range of from 0.1 to 15 phr, from 1 to 10 phr, or from 2 to 5 phr.

The catalyst mixture generally has a Lewis acid catalyst to imidazolium acetate catalyst ratio in the range of 1:10 to 10:1. Any and all amounts between 1:10 and 10:1 are included herein and disclosed herein, for example, the Lewis acid to imidazolium acetate ratio can be from 1:8 to 8:1, from 1:6 to 6:1, from 1:5 to 5:1, 1:3 to 3:1, or from 1:1.5 to 1.5:1.

Optionally, fillers can be used in the composition. Examples of inorganic fillers that can be used include, but are not limited to silica, talc, quartz, mica, and flame retardants such as aluminum trihydroxide and magnesium hydroxide.

If desired, the composition of the present invention can also contain tougheners such as carboxyl-terminated butadiene nitrile rubber, polyol type tougheners, other phase separation tougheners, and mixtures thereof.

In various embodiments, the epoxy, anhydride hardener, latent catalyst, and any additional components (if applicable) are mixed together in any combination or sub-combination to form the composition.

After the composition has been produced it may be disposed on, in or between a substrate before, during, or after cure. Examples of substrates that can be used include, but are not limited to reinforcing fibers such as glass fibers, carbon fibers or mixtures thereof.

For example, a composite may be formed by impregnating the substrate with the composition. Impregnation may be performed by various procedures, including immersing or pulling the substrate through a bath, or injecting the composition into an injection chamber. The composition can also be coated onto the substrate as a varnish.

In various embodiments, the substrate may be monolayer or multi-layer. In other various embodiments, one or more layers of the composition may be disposed on a substrate.

The catalyst can be activated when the composition has been disposed on, in, or between the substrate. Examples of how the catalyst can be activated include, but are not limited to heat (such as microwave or infrared heat), If heat is used, the catalyst is generally activated at a temperature in the range of from 50 to 200° C. but in various other embodiments from 80 to 140° C.

### Examples

The materials used are shown in Table 1, below.

TABLE 1
Raw Materials

| | | Wt % of active catalyst | |
|---|---|---|---|
| Material | Function | component | Vendor |
| VORAFORCE TP 224 | Epoxy Resin | N/A | The Dow Chemical |
| | | | Company (TDCC) |
| VORAFORCE TP 264 | Curing Agent | 1.6% | TDCC |
| | | Chromium (III) | |
| | | Carboxylate catalyst | |
| 1-Methylimidazole | Catalyst | 100% | BASF |
| Cata-1 | CH₃COOH/1-Me | 40.6% | TDCC |
| | Imidazole | | |
| Cata-2 | CF₃COOH/1-Me | 26.4% | TDCC |
| | Imidazole | | |
| Cata-3 | 1-ethyl-3-methyl | 64.7% | SCRC |
| | imidazolium acetate | | |
| Cata-4 | Primacor 3460/2-Me | 25.0% | TDCC |
| | Imidazole | | |
| Cata-5 | Rezicure 3057/2-Me | 20.5% | SI Group |
| | Imidazole | | |

### Preparation of Cata-1 and -2

Acetic acid or trifluoroacetic acid and 1-methylimidazole were placed in a flask and stirred at 100° C. for 2 hours. The mixture was cooled to room temperature and dried for use.

### Preparation of Cata-4

Primacor™ 3460 resin is an ethylene acrylic acid copolymer available from The Dow Chemical Company with a Mn of 13830 g/mol and 9.7 wt % carboxylic acid. Primacor resin was dissolved in THF in a three-neck flask. 2-methylimidazole was added in the flask and stirred at 60° C. for one hour. The mixture was cooled to room temperature and THF was removed by evaporation. The resulting solid was dried and ground to powder.

### Preparation of Cata-5

The novolac resins were obtained commercially from SI Group (U.S.A.) under the trade name ReziCure™ 3057. Novolac resin and 2-methylimidazole were placed in the flask and heated to melt under mechanical stirring at 140° C. The mixture was poured into a plastic container and cooled to ambient temperature for Pulverization.

### Preparation of Example Formulations

The resin VORAFORCE TP 224, hardener VORAFORCE TP 264 and catalyst were mixed with a speed mixer machine to yield homogeneous resin vanish formulations for the viscosity and gel time tests. The formulations are shown in Table 2, below. The Cr(III) catalyst was present at 1.6 weight percent in the TP 264. The amount of the Cr(III) catalyst was the same in all the examples.

TABLE 2
Formulations

| | Comparative | Comparative | Comparative | Inventive | Comparative | Comparative |
|---|---|---|---|---|---|---|
| | Ex 1 | Ex 2 | Ex 3 | Example 1 | Ex 4 | Ex 5 |
| TP 224 (g) | 100.0 | 100.0 | 100.0 | 100.0 | 100.0 | 100.0 |
| TP 264 (g) | 125.0 | 125.0 | 125.0 | 125.0 | 125.0 | 125.0 |
| 1-Me | 2.0 | | | | | |
| Imidazole | | | | | | |
| (g) | | | | | | |
| Cata-1 (g) | | 4.9 | | | | |
| Cata-2 (g) | | | 7.6 | | | |
| Cata-3 (g) | | | | 3.1 | | |
| Cata-4 (g) | | | | | 8.0 | |
| Cata-5 (g) | | | | | | 9.8 |

### Test Methods

Gel Time:

Hot plate: Tetrahedron model 16300 heat plate, with a metal surface capable of temperature control of the surface temperature within ±1° C. of the set point. The hot plate was set at 140° C. for 30 min to stabilize. 1 ml of prepared sample was withdrawn and placed onto the middle surface of the hot plate. The timer was started immediately and stroking begins immediately with a wooden spatula. Stroking was done by gently pushing the resin to an area of about 7 cm*7 cm. The resin gradually thickened. The resin eventually became stringy and immediately after that will became a rubbery gel which will did stick to the spatula. At this point, the timer was stopped and the gel time was recorded.

Viscosity:

The viscosity was tested at room temperature (23° C.) by an ARES G2 RHEOMETER from TA. The equipment was set up and zeroed. Then a 1 ml varnish sample was placed onto the plate, the equipment was set to be ready for the viscosity test. The viscosity was tested at 180 s and the average data for viscosity was obtained.

The results of these tests are shown in Table 3, below.

TABLE 3
Results

| | Comparative | Comparative | Comparative | Inventive | Comparative | Comparative |
|---|---|---|---|---|---|---|
| | Ex 1 | Ex 2 | Ex 3 | Example 1 | Ex 4 | Ex 5 |
| Catalysts | 1-Me | CH3COOH/1- | CF3COOH/1- | 1-ethyl-3- | Primacor | Rezicure |
| | Imidazole | Me Imidazole | Me Imidazole | methyl | 3460/2-Me | 3057/2-Me |
| | | | | imidazolium | Imidazole | Imidazole |
| | | | | acetate | | |
| Gel Time | 2′32″ | 2′55″ | 2′58″ | 1′08″ | Not | Not |
| (140° C.) | | | | | fully | fully |
| Viscosity (Pas) | 1.2911 | 1.4192 | 2.0353 | 1.4805 | dissolved | dissolved |
| RT (0 h) | | | | | | |
| Viscosity (Pas) | 3.4294 | 2.4572 | 3.27 | 2.1685 | | |
| RT (4 h) | | | | | | |
| Viscosity (Pas) | 13.4805 | 10.0241 | 23.076 | 9.0848 | | |
| RT (24 h) | | | | | | |

In conclusion, Inventive Example 1 using the latent imidazolium acetate catalyst together with Chromium (III) Carboxylate type catalyst in the formulation provided a faster get time at 140° C. and a lower viscosity increase at room temperature than the Comparative Examples.

1. A composition comprising
a) an epoxy resin;
b) an anhydride hardener; and
c) a latent catalyst which is a mixture of
i) a Lewis acid catalyst; and
ii) an imidazolium acetate catalyst.

2. The composition of claim 1, wherein the epoxy resin is present in the composition in an amount in the range of from 30 to 95 phr and the anhydride hardener is present in the composition in an amount in the range of from 1 to 60 phr.

3. The composition of any one of claims 1 or 2 wherein the imidazolium acetate catalyst is selected from the group consisting of 1-ethyl, 2-methyl-imidazolium acetate, 1,3-di-tert-butyl-imidazolium acetate, 1,3-didamantyl-imidazolium acetate, 1,3-diisopropyl-imidazolium acetate, and 1-butyl-3-methylimidazolium acetate.

4. The composition of any one of the preceding claims, wherein the Lewis acid catalyst is chromium (III) carboxylate.

5. The composition of any one of the preceding claims, wherein the latent catalyst is present in the composition in an amount in the range of from 0.1 to 15 phr.

6. The composition of any one of the preceding claims, wherein the ratio of Lewis acid catalyst to imidazolium acetate catalyst is in the range of from 1:10 to 10:1.

7. A process of making the composition of any one of the preceding claims, said process comprising
a) admixing i) the epoxy resin; ii) the anhydride hardener; and iii) the latent catalyst; and
b) activating the latent catalyst.

8. A process in accordance with claim 7, wherein the latent catalyst is activated in step b) using heat.

9. A pultrusion process using the composition of any one of claims 1-6.

10. A composite prepared by the pultrusion process of claim 9.
